(19) United States
(12) Patent Application Publication
(10) Pub. No.: US 2019/0322580 A1
(43) Pub. Date: Oct. 24, 2019

(54) PACKAGE MASK, PACKAGING METHOD AND DISPLAY PANEL

(71) Applicant: Kunshan Go-Visionox Opto-Electronics Co., Ltd., Kunshan (CN)

(72) Inventor: Min ZOU, Kunshan (CN)

(21) Appl. No.: 16/342,195

(22) PCT Filed: May 30, 2018
(86) PCT No.: PCT/CN2018/089083

§ 371 Date: Apr. 15, 2019

(30) Foreign Application Priority Data
Sep. 25, 2017 (CN) 201710874960.4

(51) Int. Cl. C03C 27/10; B32B 17/06; B32B 7/12

(52) U.S. Cl. CPC C03C 27/10; B32B 2457/20; B32B 7/12; B32B 17/06

(57) ABSTRACT

The present disclosure provides a package mask including a main body and a package slit group defined on the main body. The package slit group includes a first slit group extending along a first direction and a second slit group extending along a second direction. The first slit group includes at least two first slits, and the second slit group includes at least two second slits. A width of the first slit along the second direction is greater than a width of the second slit along the first direction.

### FIELD

The present disclosure relates to the field of display device technologies, and more particularly relates to package masks, packaging methods, and display panels.

### BACKGROUND

Conventionally, a display panel is packaged with glass cement. The glass cement is coated/printed on an edge of one of the substrates according to a designed width to form a package adhesive line. And then, the other substrate is packaged with the previous substrate by the package adhesive line to protect electronic components located between the two substrates.

In an actual production process, a height of the manufactured package adhesive line may deviate from a designed height, resulting in height deviations of the different package adhesive lines at four edges of the substrate, ultimately resulting in inconsistent heights of the package adhesive line at the four edges. In this way, an interval between the two substrates after packaging is inconsistent everywhere, which causes the display panel to have a Newton's ring phenomenon and affects the quality of the product.

### SUMMARY

Accordingly, it is necessary to provide a package mask, a packaging method, and a display panel to solve the problem that the display panel generates a Newton's ring phenomenon caused by deviations between a height of a package adhesive line and a designed height having a different tendency when the glass cement is used for packaging.

A package mask provided by the present disclosure includes a main body and a package slit defined on the main body. The package slit includes a first slit group extending along a first direction and a second slit group extending along a second direction. The first slit group includes at least two first slits, and the second slit group includes at least two second slits. A width of the first slit along the second direction is greater than a width of the second slit along the first direction.

In one of the embodiments, the first slit group and the second slit group are in communication with each other.

In one of the embodiments, the first slit group and the second package slit group are formed as an enclosed regular quadrangle.

In one of the embodiments, a ratio of the width of the first slit along the second direction to the width of the second slit along the first direction ranges from 1.15:1 to 1.25:1.

In one of the embodiments, the width of the first slit along the second direction ranges from 300 μm to 700 μm, the width of the second slit along the first direction ranges from 240 μm to 609 μm.

The present disclosure further provides a packaging method, which provides a package area by using the aforementioned mask.

In one of the embodiments, a used packaging material is glass cement.

The present disclosure further provides a display panel, which is manufactured by using the aforementioned packaging method.

In one of the embodiments, a uniformity between a height of the first package adhesive line and a height of the second package adhesive line is less than 5%.

In one of the embodiments, the height of the first package adhesive line and the height of the second package adhesive line ranges from 5.2 μm to 5.7 μm.

The aforementioned package mask includes the main body and the package slit formed through the main body. The package slit includes the first slit group extending along the first direction and the second slit group extending along the second direction. The first slit group includes at least two first slits, and the second slit group includes at least two second slits. By configuring the width of the first slit along the second direction greater than the width of the second slit along the first direction, when a packaging material is printed onto the substrate along the first direction by a material scraper, the second slit can be made to have a smaller amount of ink permeation with respect to the first slit. The smaller amount of ink permeation can reduce a contact area with the material scraper, thereby reducing the pressure of the material scraper. Therefore, the uniformity between the height of the second package adhesive line formed according to the second slit and the height of the first package adhesive line formed according to the first slit can be improved, so that the interval between the two substrates of the display panel after packaging is equal everywhere, thereby avoiding the generation of Newton's ring and improving the quality of the display panel.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a schematic view of a package mask and a traveling direction of a material scraper according to an embodiment of the present disclosure.

### DETAILED DESCRIPTION OF THE EMBODIMENTS

In order to make the objective, technical solutions and advantages of the present disclosure more clear, the package mask, the packaging method, and a display panel of the present disclosure will be further described in detail below with reference to the accompanying drawings and embodiments. It is understood that the specific embodiments described herein are merely illustrative of the application and are not intended to be limiting.

Conventionally, display panels tend to produce Newton's rings. For example, an in-plane switching panel (IPS panel) is packaged by glass cement, and the glass cement is printed on four edges of the first substrate according to a designed width to form a package adhesive line. The designed width is determined by a width of a slit of the mask, so that four package adhesive lines are formed on the four edges of the first substrate, respectively, and the first substrate and the second substrate are packaged together by using the four glass adhesive lines. However, a Newton's ring phenomenon is often generated between the first substrate and the second substrate, which affects the packaging effect of the display panel. The inventors of the present disclosure have found that, in the display panel manufactured by using the aforementioned scheme, the final heights of the four package adhesive lines are inconsistent, causing an interval between the first substrate and the second substrate after packaging to be different everywhere, resulting in a Newton's ring phenomenon.

The inventors have also surprisingly found that there is a deviation between the final width of the four package adhesive lines and the designed width, and the tendency of the deviation is inconsistent. Even if the designed widths of the four package adhesive lines are same, the deviation tendency of the final widths of the four package adhesive lines after printing with a mask is also different. On the basis of this finding, the inventors have proposed this disclosure through further research.

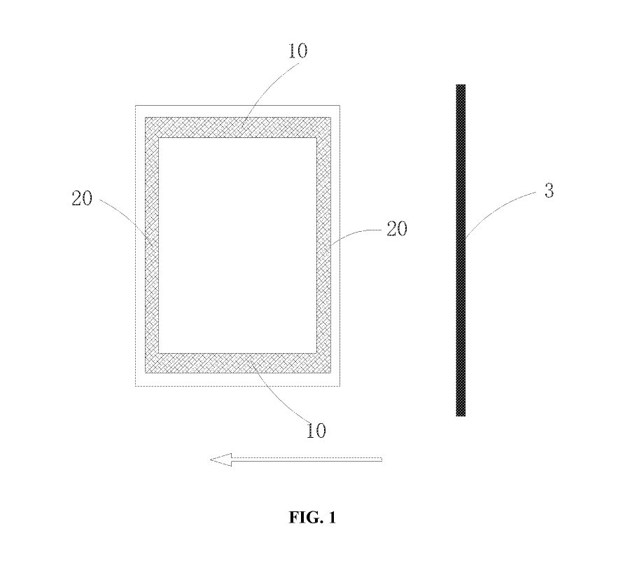

Referring to FIG. 1, the present disclosure provides a package mask including a main body and a package slit defined on the main body. The package slit includes a first slit group extending along a first direction and a second slit group extending along a second direction. The first slit group includes at least first slits, and the second slit group includes at least two second slits. A width of the first slit along the second direction is greater than a width of the second slit along the first direction. When this package mask is used for packaging, a first package adhesive line is provided corresponding to the first slit, and a second package adhesive line is provided corresponding to the second slit. The main body can be of a plate shape.

By configuring the width of the first slit along the second direction greater than the width of the second slit along the first direction, when the packaging material is printed onto the substrate along the first direction by a material scraper, the second slit can be made to have a smaller amount of ink permeation with respect to the first slit. The smaller amount of ink permeation can reduce the contact area with the material scraper, thereby reducing the pressure of the material scraper. Therefore, the uniformity between the height of the second package adhesive line formed according to the second slit and the height of the first package adhesive line formed according to the first slit can be improved, so that the interval between the two substrates of the display panel after packaging is equal everywhere, thereby avoiding the generation of Newton's ring and improving the quality of the display panel.

As an alternative embodiment, the first slit group and the second slit group are in communication with each other. The plurality of first slits included in the first slit group and the plurality of second slits included in the second slit group intersect and are in communication with each other to form a mesh structure on the mask. A shape of the mesh structure is configured according to packaging requirements so as to form a mesh-connected package adhesive line via the mask.

Optionally, the first slit group and the second package slit group form an enclosed regular quadrangle so as to form an enclosed regular quadrangular adhesive line on the substrate.

Referring to FIG. 1, a mask having an enclosed regular quadrangle of a printed structural unit is shown. A direction of an arrow indicates a printing direction of the material scraper 3. The printing direction is same as the first direction.

The process of printing the glass cement on the substrate is introduced below. The mask is disposed on the substrate, the package adhesive is coated in the first slit group and the second slit group, and then the material scraper 3 is operated along the first direction on a surface of the mask, the package adhesive is pressed into the first slit 10 of the first slit group and the second slit 20 of the second slit group while excess package adhesive is scraped off. Therefore, an end-to-end package adhesive line is formed in the first slit group and the second slit group of the mask of one package structure unit. The first package adhesive line is manufactured according to the first slit 10, and the second package adhesive line is manufactured according to the second slit 20.

The printing processes of the first package adhesive line and the second package adhesive line are compared. During the operation of the material scraper 3 along the first direction, a contact area of the material scraper 3 in contact with the first slit 10 is less than a contact area of the material scraper 3 in contact with the second slit 20, the pressure of the package adhesive in the first slit 10 by the material scraper 3 is also relatively small, with respect to that in the second slit 20. Therefore, a value of the final width of the first package adhesive line deviates from the width of the first slit 10 along the second direction is less than that of the final width of the second package adhesive line deviates from the width of the second slit 20 along the first direction. A final height of the first package adhesive line is higher than a final height of the second package adhesive line. In the present disclosure, by configuring the area per unit length of the first slit group greater than the area per unit length of the second slit group, the contact area of the first slit 10 in contact with the material scraper 3 can be increased for compensating the difference of the contact area of the first slit 10 extending along the first direction in contact with the material scraper 3 from the contact area of the second slit 20 extending along the second direction in contact with the material scraper 3. Therefore, the amount of ink permeation in the first slit 10 can be increased, that is, the amount of the package adhesive entering the first slit 10 is increased, thereby the pressure of the package adhesive entering the first slit 10 generated by the material scraper 3 is increased, so that the height of the first package adhesive line formed by the package adhesive in the first slit 10 is reduced, and finally the uniformity of the final height of the first package adhesive line and the final height of the second package adhesive line has been improved.

As an alternative embodiment, a ratio of the width of the first slit 10 along the second direction to the width of the second slit 20 along the first direction ranges from 1.15:1 to 1.25:1.

The present disclosure has found through research that the resulting final width has a certain relationship with the final height under the same width of the slit. The greater the final width of the package adhesive line is, the lower the final height is. Conversely, the less the final width of the package adhesive line is, the higher the final height is. In addition, according to the different influences of the printing direction (the traveling direction of the material scraper 3) on the package adhesive lines manufactured according to the first slit group and the second slit group, the ratio of the width of the first slit 10 along the second direction to the width of the second slit 20 along the first direction is adjusted to be from 1.15:1 to 1.25:1, so as to finally offset the different influences of the printing direction on the package adhesive line according to the first slit group and the second slit group, so that the final width of the manufactured first package adhesive line is unified with the final width of the second package adhesive line, and the final height of the first package adhesive line is unified with the final height of the second package adhesive line. Therefore, the Newton's ring phenomenon occurs due to the inconsistency of the interval between the two substrates after the first package adhesive line and the second package adhesive line are packaged can be avoided.

As an alternative embodiment, in addition, the width of the first slit 10 along the second direction ranges from 300 μm to 700 μm, and the width of the second slit 20 along the first direction ranges from 240 μm to 609 μm.

By further configuring the width of the first slit 10 along the second direction from 300 μm to 700 μm and the width of the second slit 20 along the first direction from 240 μm to 609 μm, the final width of the first package adhesive line and the second package adhesive line can be made within a suitable range after printing, and the packaging requirements of the display panel can be satisfied, and the packaging effect can be further improved.

It should be noted that the width of the first slit 10 along the second direction and the width of the second slit 20 along the first direction are designed according to the product size and the size of the product frame, or are designed according to the packaging effect. Generally, the greater the width of the slit is, the greater the width of the corresponding sealant line is, and the better the sealing effect will be.

A second aspect of the present disclosure further provides a packaging method, a package area is provided by the aforementioned mask, forming a first package adhesive line corresponding to a first slit group, and forming a second package adhesive line corresponding to a second slit group. Since the aforementioned mask has the above technical effects, the packaging method using the above mask for packaging should also have the same technical effect, and will not be described in detail herein.

Optionally, the packaging method includes the following steps of:

a first substrate is provided;

the aforementioned mask is disposed on the first substrate;

the package adhesive is coated in the first slit group and the second slit group of the mask; and

the material scraper 3 is traveled along the first direction on a surface of the mask, the package adhesive is pressed into the first slit group and the second slit group, and the excess package adhesive are scraped off.

As an alternative embodiment, the used packaging material is glass cement. Optionally, the glass cement has a viscosity of 40,000 cps to 200,000 cps. By controlling the viscosity of the glass cement, the flowability of the glass cement is controlled to a certain extent to ensure that the final height of the package adhesive line is within the required range.

A third aspect of the present disclosure further provides a display panel, which is manufactured by the aforementioned packaging method. Since the aforementioned packaging method has the above technical effects, the display panel manufactured by the above packaging method should also have the same technical effect, and will not be described in detail herein.

As an alternative embodiment, a uniformity between a height of the first package adhesive line and a height of the second package adhesive line is less than 5%. The display panel adopts the above packaging method, and can significantly improve the uniformity of the height of the first package adhesive line and the second package adhesive line, and reduce the uniformity of the height of the first package adhesive line and the second package adhesive line to 5%. The interval between the two substrates of the display panel obtained by packaging is equal, and the Newton's ring due to the uneven interval can be avoided, thereby improving the quality of the display panel.

As an alternative embodiment, the height of the first package adhesive line and the height of the second package adhesive line are 5.2 μm to 5.7 μm. It can meet the packaging requirements of the display panel and further improve the packaging effect.

### Comparative Example 1

A batch packaging production was carried out with a mask having a width of the first slit 10 along the second direction of 450 μm and a width of the second slit 20 along the first direction of 450 μm, and the obtained statistical data were shown in Table 1.

### Example 2

A batch packaging production was carried out with a mask having a width of the first slit 10 along the second direction of 550 μm and a width of the second slit 20 along the first direction of 450 μm, and the obtained statistical data were shown in Table 2.

TABLE 1
Statistical data for batch products of Comparative Example 1

| | Width | | Height/Depth | |
|---|---|---|---|---|
| | First | Second | First | Second |
| | package | package | package | package |
| | adhesive | adhesive | adhesive | adhesive |
| Item | line | line | line | line |
| Slit/μm | 450 | 450 | 5.80 | 5.80 |
| Final value/μm | 464.5 | 506.3 | 5.80 | 5.32 |
| Deviation | 14.5 | 56.3 | 0.35 | 0.13 |
| value/μm | | | | |
| Uniformity/% | 2.15 | 3.28 | 4.71 | 7.82 |

TABLE 2
Statistical data for batch products of Example 1

| | Width | | Height/Depth | |
|---|---|---|---|---|
| | First | Second | First | Second |
| | package | package | package | package |
| | adhesive | adhesive | adhesive | adhesive |
| Item | line | line | line | line |
| Slit/μm | 550 | 450 | 5.80 | 5.80 |
| Final value/μm | 564.0 | 504.3 | 5.35 | 5.21 |
| Deviation | 14.0 | 54.3 | 0.1 | 0.24 |
| value/μm | | | | |
| Uniformity/% | 1.35 | 4.72 | 5.38 | 5.71 |

It should be noted that, in Tables 1 and 2, the slits refer to the first slit 10 and the second slit 20 corresponding to the first package adhesive line and the second package adhesive line, respectively. The final value is an average of the final width/height of the batch products. The deviation value is a difference between the final value minus a predetermined value.

In the present disclosure, uniformity=(maximum value−minimum value)/(maximum value+minimum value), the maximum value refers to a maximum value of the final width/height in the batch products, and the minimum value refers to a minimum value of the final width/height in the batch products. By calculating the uniformity, it is possible to acknowledge the deviation of the final width/height of the package adhesive line from the predetermined width/height. The predetermined width is the width of the corresponding slit, and the predetermined height is the depth of the corresponding slit.

As can be seen from the analysis of the data measured in Tables 1 and 2, when the width of the first slit 10 of the mask along the second direction is same as the width of the second slit 20 along the first direction, the final width of the first package adhesive line and the second package adhesive line are different, and the deviation tendency of the final widths is also different. In addition, the final heights of the first package adhesive line and the second package adhesive line are different, and the deviation tendency of the final heights is also different. Moreover, the final widths of the first package adhesive line and the second package adhesive line have a certain relationship with the final heights thereof. The greater the final widths of the package adhesive line are, the lower the final heights are. Conversely, the less the final widths of the package adhesive line are, the higher the final heights are.

Furthermore, the present disclosure derives the width of the first slit 10 along the second direction and the width of the second slit 20 along the first direction based on the analysis of the final width and the final height of the first package adhesive line and the second package adhesive line.

TABLE 3
Calculation data of the cross-sectional area of the package
adhesive line of the batch products

| | Comparative example 1 | | Example 1 | |
|---|---|---|---|---|
| | First | Second | First | Second |
| | package | package | package | package |
| | adhesive | adhesive | adhesive | adhesive |
| Item | line | line | line | line |
| Width of slit/μm | 450 | 450 | 550 | 450 |
| Final width/μm | 464.5 | 506.3 | 564.0 | 504.3 |
| Final height/μm | 5.80 | 5.32 | 5.35 | 5.31 |
| Cross-sectional | 2694.1 | 2693.5 | 3017.4 | 2677.8 |
| area of package | | | | |
| adhesive line/μm² | | | | |

It should be noted that, in Table 3, the widths of the slits refer to the width of the first slit 10 corresponding to the first package adhesive line along the second direction and the width of the second slit 20 corresponding to the second package adhesive line along the first direction, respectively. The cross-sectional area of the adhesive line is a longitudinal cross-sectional area of the first package adhesive line along the second direction or a longitudinal cross-sectional area of the second package adhesive line along the first direction.

Referring to Table 3, and the calculation data of the cross-sectional area of the package adhesive line of the batch products, the actual longitudinal cross-sectional areas of the first package adhesive line of Comparative Example 1, the second package adhesive line of Comparative Example 1, the first package adhesive line of Example 1, and the second package adhesive line of Example 1 are assumed to be V₁, V₂, V₃, and V₄, respectively. The final widths thereof are L₁, L₂, L₃, and L₄, respectively, and the final heights thereof are H₁, H₂, H₃, and H₄, respectively. V₁=L₁*H₁, V₂=L₂*H₂, V₃=L₃*H₃, and V₄=L₄*H₄.

V₂=V₄, L₂=L₄, and H₂=H₄.

The second package adhesive line of Comparative Example 1 and the second package adhesive line of Embodiment 1 are both package adhesive lines extending along the second direction perpendicular to the printing direction. The degree of deviation of the final width thereof with respect to the width of the second slit 20 along the first direction is uniform, and the resulting final width is also close.

Assuming V₁=V₃ and L₁=L₃, then H₁=H₃.

The first package adhesive line of Comparative Example 1 and the first package adhesive line of Embodiment 1 are both package adhesive lines extending along the first direction parallel to the printing direction. The degree of deviation of the final width thereof with respect to the width of the slit should also be same, and the resulting final width is also close.

Therefore, the widths of the slits corresponding to the mutually parallel package adhesive lines can be made same, so that the final widths and final heights of the two mutually parallel package adhesive lines are same.

When V₂=V₁, L₁/L₂=H₂/H₁=0.917, that is, L₁≠L₂, and H₂≠H₁.

The first package adhesive line of Comparative Example 1 refers to the package adhesive line extending along the first direction parallel to the printing direction. The second package adhesive line refers to the package adhesive line extending along the second direction perpendicular to the printing direction. The width of the first slit 10 along the second direction corresponding to the above-mentioned first package adhesive line and the width of the second slit 20 along the first direction corresponding to the above-mentioned second package adhesive line are same. However, the final widths and final heights of the first package adhesive line and the second package adhesive line are different. The final width of the first package adhesive line is narrower than the final width of the second package adhesive line, and the final height of the first package adhesive line is higher than the final height of the second package adhesive line.

Therefore, if the final heights of the first package adhesive line and the second package adhesive line are to be same, according to the concept of the present disclosure, it is required to increase the final width of the first package adhesive line, that is, the width of the first slit 10 corresponding to the first package adhesive line along the second direction needs to be relatively increased.

When H₄=H₃, V₃V₄=(H₃*L₃)/(H₄*L₄₄)=V₃/V₄=L₃/L₄=564.0/504.3=1.19.

The first package adhesive line of Example 1 is the package adhesive line extending along the first direction parallel to the printing direction, the second package adhesive line of Example 1 is the package adhesive line extending along the second direction perpendicular to the printing direction. The width of the first slit 10 along the second direction and the width of the second slit 20 along the first direction respectively corresponding to the two are different. However, the final height of the resulting first package adhesive line is closer to that of the resulting second package adhesive line. Therefore, it is proved that if the final heights of the first package adhesive line and the second package adhesive line are to be same, the width of the corresponding first slit 10 along the second direction and the width of the second slit 20 along the first direction need to be adjusted accordingly.

In addition, by a large amount of data statistics, the present disclosure has found that the ratio of the width of the first slit 10 along the second direction to the width of the second slit 20 along the first direction is configured to be from 1.15:1 to 1.25:1, which can offset the different degrees of the pressure actions of the packaging material in the first slit 10 and the packaging material in the second slit 20 by the material scraper 3. Therefore, the uniformity of the final heights of the first package adhesive line and the second package adhesive line is high, preventing the generation of Newton's ring. In addition, the final height of the first package adhesive line is consistent with that of the second package adhesive line. The packaging effect would be improved, the sealing effect would be improved, and the water blocking and oxygen resistance effect would be improved. Moreover, the ratio of the width of the first slit 10 along the second direction to the width of the second slit 20 along the first direction is configured to be from 1.15:1 to 1.25:1, so that the final heights of the first package adhesive line and the second package adhesive line are 5.2 μm to 5.7 μm, thereby satisfying the sealing requirement.

Furthermore, the ratio of the width of the first slit 10 along the second direction to the width of the second slit 20 along the first direction is configured to be 1.2:1, so that the uniformity of the final heights of the first package adhesive line and the second package adhesive line can be further improved, and the final heights of the first package adhesive line and the second package adhesive line are controlled to be 5.3 μm to 5.6 μm.

Hereinafter, the technical effect of the uniformity of the actual height of the first package adhesive line and the second package adhesive line manufactured by the mask of the present disclosure is further verified by Example 2.

### Example 2

A batch packaging production was carried out with a mask, the mask has a first slit group and a second slit group which are formed as an enclosed regular quadrangle, a width of the first slit 10 along the second direction of 550 μm, and a width of the second slit 20 along the first direction of 450 μm. The obtained statistical data were shown in Table 4.

TABLE 4
Statistical data for batch products of Example 2 of the
present disclosure

| | Width | | Height/Depth | |
|---|---|---|---|---|
| | First | Second | First | Second |
| | package | package | package | package |
| | adhesive | adhesive | adhesive | adhesive |
| Item | line | line | line | line |
| Slit/μm | 550 | 450 | 5.45 | 5.45 |
| Final value/μm | 574 | 493 | 5.37 | 5.43 |
| Deviation | 24 | 43 | 0.08 | 0.02 |
| value/μm | | | | |
| Uniformity/% | 1.27 | 3.31 | 4.09 | 3.81 |

It should be noted that, in Table 4, the slits refer to the first slit 10 and the second slit 20 corresponding to the first package adhesive line and the second package adhesive line, respectively. The final value refers to an average of the final width/height of the batch products. The deviation value refers to a difference between the final value minus a predetermined value.

The statistical results in Table 4 further verify that, the uniformity of the final height of the package adhesive line provided by the mask of the present disclosure is improved, so that the interval between the two substrates of the display panel after packaging can be equal, the generation of Newton's ring is avoided, and the quality of the display panel is improved.

In the description of the present disclosure, the terms “first” and “second” are used for descriptive purposes only and are not to be construed as indicating or implying relative importance.

In addition, terms such as “upper”, “lower”, “left”, “right”, “intermediate” and “one” used in this specification are used also for convenience of description, and are not intended to limit the scope of the application. Changes or adjustments in their relative relationship are considered to be within the scope of this application if they are not materially altered.

The foregoing descriptions are merely specific embodiments of the present invention, but are not intended to limit the protection scope of the present invention. Any variation or replacement readily figured out by a person skilled in the art within the technical scope disclosed in the present invention shall all fall within the protection scope of the present invention. Therefore, the protection scope of the present invention shall be subject to the protection scope of the appended claims.

1. A package mask, comprising:
a main body, and
a package slit group defined on the main body, the package slit group comprising a first slit group extending along a first direction and a second slit group extending along a second direction, the first slit group comprising at least two first slits each for manufacturing a first package adhesive line, the second slit group comprising at least two second slits each for manufacturing a second package adhesive line, a width of the first slit along the second direction being greater than a width of the second slit along the first direction.

2. The package mask according to claim 1, wherein the first slit group and the second slit group are in communication with each other.

3. The package mask according to claim 2, wherein the first slit group and the second package slit group are formed as an enclosed regular quadrangle.

4. The package mask according to claim 3, wherein a ratio of the width of the first slit along the second direction to the width of the second slit along the first direction ranges from 1.15:1 to 1.25:1.

5. The package mask according to claim 4, wherein the width of the first slit along the second direction ranges from 300 μm to 700 μm, the width of the second slit along the first direction ranges from 240 μm to 609 μm.

6. A packaging method, comprising providing a package area by using a package mask of claim 1, forming a first package adhesive line corresponding to the first slit group, and forming a second package adhesive line corresponding to the second slit group.

7. The packaging method according to claim 6, wherein a used packaging material is glass cement.

8. A display panel manufactured by using a packaging method of claim 6.

9. The display panel according to claim 8, wherein a uniformity between a height of a first package adhesive line and a height of a second package adhesive line is less than 5%.

10. The display panel according to claim 8, wherein a height of the first package adhesive line and a height of the second package adhesive line range from 5.2 μm to 5.7 μm.

11. The display panel according to claim 10, wherein the height of the first package adhesive line and the height of the second package adhesive line range from 5.3 μm to 5.6 μm.

12. The package mask according to claim 4, wherein the ratio of the width of the first slit along the second direction to the width of the second slit along the first direction is 1.2:1.

13. The package mask according to claim 1, wherein a uniformity between a height of the first package adhesive line and a height of the second package adhesive line is less than 5%.

14. The package mask according to claim 1, wherein a height of the first package adhesive line and a height of the second package adhesive line range from 5.2 μm to 5.7 μm.

15. The package mask according to claim 1, wherein a height of the first package adhesive line and a height of the second package adhesive line range from 5.3 μm to 5.6 μm.

16. The package mask according to claim 1, wherein the first slit group and the second slit group are formed as a mesh structure.

17. The packaging method according to claim 6, wherein forming the first package adhesive line corresponding to the first slit group and forming the second package adhesive line corresponding to the second slit group comprises:
providing a first substrate;
disposing the package mask on the first substrate;
coating a package adhesive in the first slit group and the second slit group; and
operating a material scraper along the first direction on a surface of the mask to remove an excess package adhesive.

18. The packaging method according to claim 7, wherein the glass cement has a viscosity of 40,000 cps to 200,000 cps.
